(19) United States
(12) Patent Application Publication
(10) Pub. No.: US 2023/0049280 A1
(43) Pub. Date: Feb. 16, 2023

(54) NANOCRYSTALLINE SOFT MAGNETIC ALLOY

(71) Applicants: TOHOKU MAGNET INSTITUTE CO., LTD., Natori-shi, Miyagi (JP); NATIONAL INSTITUTE FOR MATERIALS SCIENCE, Tsukuba-shi, Ibaraki (JP)

(72) Inventors: Tatsuya Tomita, Natori-shi (JP); Yohei Nomura, Natori-shi (JP); Jun Uzuhashi, Tsukuba-shi (JP); Tadakatsu Ohkubo, Tsukuba-shi (JP); Kazuhiro Hono, Tsukuba-shi (JP)

(73) Assignees: TOHOKU MAGNET INSTITUTE CO., LTD., Natori-shi, Miyagi (JP); NATIONAL INSTITUTE FOR MATERIALS SCIENCE, Tsukuba-shi, Ibaraki (JP)

(21) Appl. No.: 17/788,964

(22) PCT Filed: Dec. 22, 2020
(86) PCT No.: PCT/JP2020/047990

§ 371 Date: Jun. 24, 2022

(30) Foreign Application Priority Data
Dec. 25, 2019 (JP) 2019-234390

(51) Int. Cl. C22C 38/16

(52) U.S. Cl. CPC C22C 38/16; C22C 2202/02

(57) ABSTRACT

The present invention is an alloy that contains Fe, B, P, and Cu, and includes a non-crystalline phase and a plurality of crystalline phases formed in the non-crystalline, wherein an average Fe concentration in a whole alloy is 79 atomic % or greater, and wherein a density of Cu clusters when a region with a Cu concentration of 6.0 atomic % or greater among regions with 1.0 nm on a side in atom probe tomography is determined to be a Cu cluster is 0.20×10²⁴/m³.

### TECHNICAL FIELD

The present invention relates to a nanocrystalline soft magnetic alloy, for example, to a nanocrystalline soft magnetic alloy containing Fe, B, P, and Cu.

### BACKGROUND ART

Nanocrystalline alloys have a plurality of nano-sized crystalline phases formed in a non-crystalline phase, and Fe—B—P—Cu alloys with high saturation magnetic flux density and low coercivity are known as such nanocrystalline alloys (for example, Patent Documents 1 to 5). Such nanocrystalline alloys are used as soft magnetic materials with high saturation magnetic flux density and low coercivity.

### PRIOR ART DOCUMENT

### Patent Document

Patent Document 1: International Publication No. 2010/021130

Patent Document 2: International Publication No. 2017/006868

Patent Document 3 International Publication No. 2011/122589

Patent Document 4: Japanese Patent Application Publication No. 2011-256453

Patent Document 5: Japanese Patent Application Publication No. 2013-185162

### SUMMARY OF THE INVENTION

### Problem to be Solved by the Invention

The crystalline phase is mainly an iron alloy with a body-centered cubic (BCC) structure, and as the size of the crystalline phase decreases, the soft magnetic properties such as coercivity improve. However, further improvement in soft magnetic properties of nanocrystalline soft magnetic alloys is desired.

The present invention has been made in view of above problems, and aims to improve the soft magnetic properties of the alloy.

### Means for Solving the Problem

The present invention is an alloy that contains Fe, B, P and Cu, and includes a non-crystalline phase and a plurality of crystalline phases formed in the non-crystalline, wherein an average Fe concentration in a whole alloy is 79 atomic % or greater, and wherein a density of Cu clusters when a region with a Cu concentration of 6.0 atomic % or greater among regions with 1.0 nm on a side in atom probe tomography is determined to be a Cu cluster is 0.20×10²⁴/m³.

The present invention is an alloy that contains Fe, B, P, and Cu, and includes a non-crystalline phase and a plurality of crystalline phases formed in the non-crystalline phase, wherein an average Fe concentration in a whole alloy is 79 atomic % or greater, and wherein an average Fe concentration in a region with an Fe concentration of 80 atomic % or less among regions with 1.0 nm on a side in atom probe tomography is 74.5 atomic % or less.

The present invention is an alloy that contains Fe, B, P, and Cu, and includes a non-crystalline phase and a plurality of crystalline phases formed in the non-crystalline phase, wherein an average Fe concentration in a whole alloy is 79 atomic % or greater, and wherein a value obtained by dividing an average B atomic concentration in a region with an Fe concentration of 90 atomic % or greater among regions with 1.0 nm on a side in atom probe tomography by a square root of an average B atomic concentration in the whole alloy is 0.56 atomic %^{0.5} or greater.

The present invention is an alloy that contains Fe, B, P, and Cu, and includes a non-crystalline phase and a plurality of crystalline phases formed in the non-crystalline phase, wherein an average Fe concentration in a whole alloy is 79 atomic % or greater, and wherein a value obtained by dividing an average Cu atomic concentration in a region with an Fe concentration of 80 atomic % or less among regions with 1.0 nm on a side in atom probe tomography by an average Cu atomic concentration in a region with an Fe concentration of 90 atomic % or greater among the regions is 1.8 or greater.

The present invention is an alloy that contains Fe, B, P, and Cu, and includes a non-crystalline phase and a plurality of crystalline phases formed in the non-crystalline phase, wherein an average Fe concentration in a whole alloy is 79 atomic % or greater, and wherein in a proxigram of regions with 1.0 nm on a side in atom probe tomography with respect to a boundary with an Fe concentration of 80 atomic %, a slope of an Fe concentration through a position of −2.0 nm from the boundary and a position of −4.0 nm from the boundary is 0.03 atomic %/nm or greater when a direction toward the crystalline phase is defined as positive.

The present invention is an alloy that contains Fe, B, P, and Cu, and includes a non-crystalline phase and a plurality of crystalline phases formed in the non-crystalline phase, wherein an average Fe concentration in a whole alloy is 79 atomic % or greater, and wherein a value obtained by dividing a density of Cu clusters when a region with a Cu concentration of 1.5 atomic % or greater among regions with 1.0 nm on a side in atom probe tomography is determined to be a Cu cluster by a density of Cu clusters when a region with a Cu concentration of 6.0 atomic % or greater among the regions is determined to be a Cu cluster is 15 or less.

The present invention is an alloy that contains Fe, B, P, and Cu, and includes a non-crystalline phase and a plurality of crystalline phases formed in the non-crystalline phase, wherein an average Fe concentration in a whole alloy is 79 atomic % or greater, and wherein in a region with an Fe concentration of 80 atomic % or less among regions with 1.0 nm on a side in atom probe tomography, an average spherical equivalent diameter of Cu clusters when a region with a Cu concentration of 2.3 atomic % or greater among the regions is determined to be a Cu cluster is 3.0 nm or greater.

In the above configuration, it may be possible to employ the configuration in which the average Fe concentration in the whole alloy is 83 atomic % or greater and 88 atomic % or less, an average B concentration in the whole alloy is 2.0 atomic % or greater and 12 atomic % or less, an average P concentration in the whole alloy is 2.0 atomic % or greater and 12 atomic % or less, an average Cu concentration in the whole alloy is 0.4 atomic % or greater and 1.4 atomic % or less, a sum of an average Si concentration and an average C concentration in the whole alloy is 0 atomic % or greater and 3.0 atomic % or less, and an average atomic concentration of an element other than Fe, B, P, Cu, Si, and C in the whole alloy is 0 atomic % or greater and 0.3 atomic % or less.

In the above configuration, it may be possible to employ the configuration in which a value obtained by dividing an average B atomic concentration by an average P atomic concentration in the whole alloy is 1.5 or greater and 3.5 or less.

In the above configuration, it may be possible to employ the configuration in which a value obtained by dividing a density of Cu clusters when a region with a Cu concentration of 1.5 atomic % or greater among the regions is determined to be a Cu cluster by an average Cu atomic concentration in the whole alloy is 3.0×10²⁴/m²⁴/3/atomic % or less.

In the above configuration, it may be possible to employ the configuration in which a value obtained by dividing an average P atomic concentration in a region with an Fe concentration of 90 atomic % or greater among the regions by an average P atomic concentration in the whole alloy is 0.36 or less.

In the above configuration, it may be possible to employ the configuration in which a value obtained by dividing an average P atomic concentration in a region with an Fe concentration of 80 atomic % or less among the regions by an average P atomic concentration in the whole alloy is 1.6 or greater.

In the above configuration, it may be possible to employ the configuration in which in a proxigram of the regions with respect to a boundary with an Fe concentration of 80 atomic %, a maximum value of a Cu concentration is 1.25 atomic % or greater within a range of ±5.0 nm from the boundary.

In the above configuration, it may be possible to employ the configuration in which in a proxigram of the regions with respect to a boundary with an Fe concentration of 80 atomic %, P atomic concentration/B atomic concentration has a local minimum value and a local maximum value within a range of ±5.0 nm from the boundary.

In the above configuration, it may be possible to employ the configuration in which in a proxigram of the regions with respect to a boundary with an Fe concentration of 80 atomic %, a local maximum value of P atomic concentration/B atomic concentration is 1.0 or greater within a range of ±3.0 nm from the boundary.

In the above configuration, it may be possible to employ the configuration in which in a proxigram of the regions with respect to a boundary with an Fe concentration of 80 atomic %, a value obtained by dividing a local maximum value of P atomic concentration/B atomic concentration within a range of ±3.0 nm from the boundary by average P atomic concentration/average B atomic concentration in the whole alloy is 1.0 or greater.

In the above configuration, it may be possible to employ the configuration in which in a region with an Fe concentration of 80 atomic % or greater among the regions, an average spherical equivalent diameter of Cu clusters when a region with a Cu concentration of 2.3 atomic % or greater among the regions is determined to be a Cu cluster is 3.0 nm or greater.

### Effects of the Invention

The present invention can improve the soft magnetic properties of the alloy.

### BRIEF DESCRIPTION OF THE DRAWINGS

FIG. 1 is a schematic view illustrating variation in temperature with respect to time for describing a model for nanocrystalline alloy formation;

FIG. 2A to FIG. 2C are schematic views describing the model for the nanocrystalline alloy formation;

FIG. 3A to FIG. 3C are schematic views describing the model for the nanocrystalline alloy formation;

FIG. 4A to FIG. 4C are schematic views illustrating the vicinity of the boundary between a crystalline phase and a non-crystalline phase for describing the model for the nanocrystalline alloy formation;

FIG. 5A is a diagram for describing a method of evaluating Cu clusters, and FIG. 5B is a diagram for describing a method of setting an Fe concentration region;

FIG. 6A and FIG. 6B are proxigrams in Examples 1 and 2, respectively; and

FIG. 7A and FIG. 7B are proxigrams in a Comparative example 1 and Example 3, respectively.

### MODES FOR CARRYING OUT THE INVENTION

### Hypothesis of the Model for Nanocrystalline Alloy Formation

The size (the grain size) of the crystalline phase in the nanocrystalline alloy (the nanocrystalline soft magnetic alloy) affects the soft magnetic properties such as coercivity. When the size (the grain size) of the crystalline phase is small, the coercivity is small. As a result, the soft magnetic properties improve. The inventors hypothesized a model for the nanocrystalline alloy formation, taking into account the influence of factors other than the size of the crystalline phase on the soft magnetic properties.

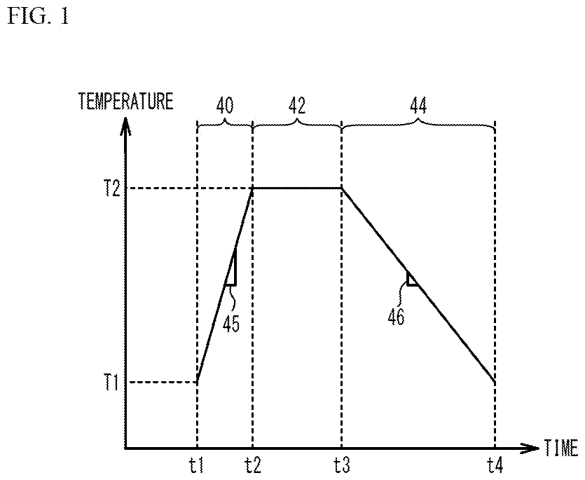

FIG. 1 is a schematic view (a schematic diagram of the temperature history of heat treatment) illustrating variation in temperature with respect to time for describing the model of the nanocrystalline alloy formation. The precursor alloy (the starting material) is a non-crystalline alloy (an amorphous alloy). As illustrated in FIG. 1, at time t1, the material is a non-crystalline alloy, and the temperature T1 is, for example, 200° C. During a heating period 40 from time t1 to time t2, the temperature of the alloy increases from T1 to T2 at, for example, an average heating rate 45. The temperature T2 is higher than the temperature at which the crystalline phase (the metallic iron crystalline phase), which is iron with a BCC structure, starts to form (the temperature slightly lower than the first crystallization starting temperature Tx1), and is lower than the temperature at which the crystalline phase of the compound (the compound crystalline phase) starts to form (the temperature slightly lower than the second crystallization starting temperature Tx2). During a retention period 42 from time t2 to time t3, the temperature of the alloy is at a substantially constant temperature T2. During a cooling period 44 from time t3 to time t4, the temperature of the alloy decreases from T2 to T1 at, for example, an average cooling rate 46. In FIG. 1, the heating rate 45 and the cooling rate 46 are constant, but the heating rate 45 and the cooling rate 46 may vary with time.

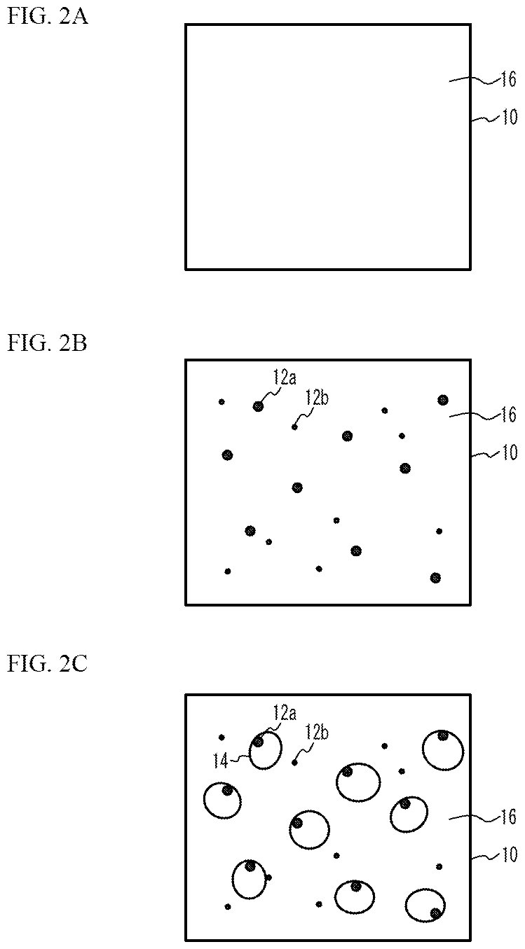

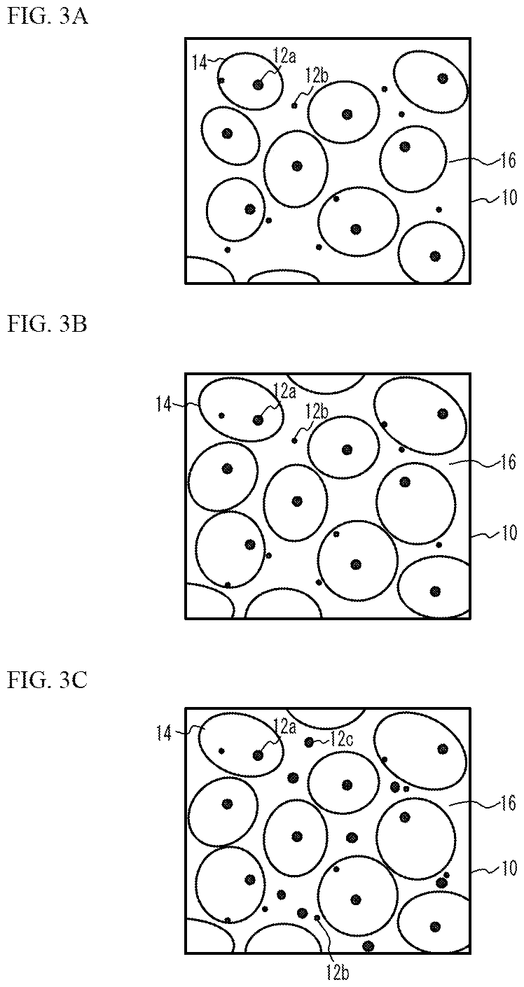

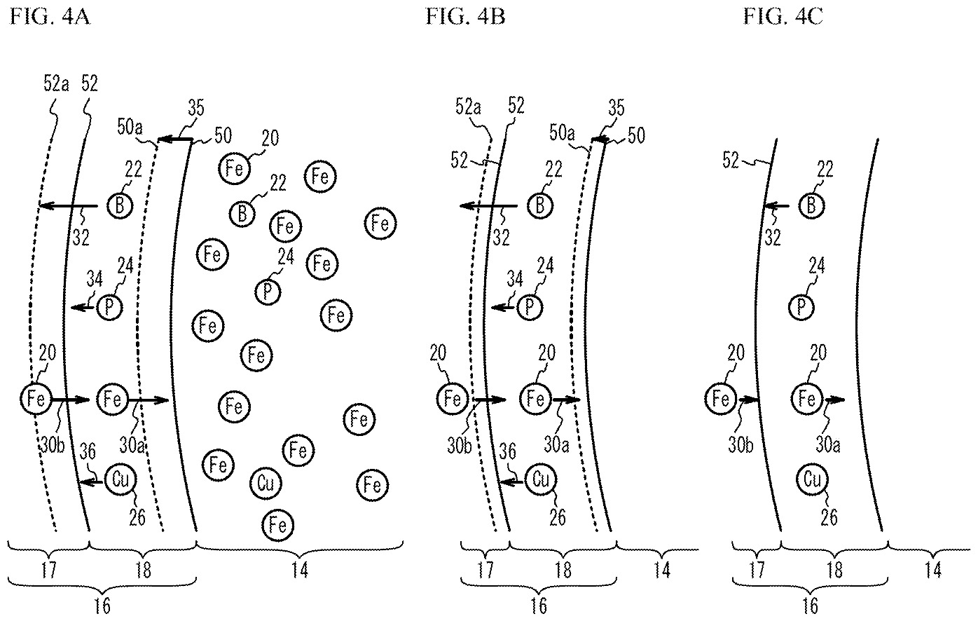

FIG. 2A to FIG. 3C are schematic views describing the model for the nanocrystalline alloy formation. FIG. 4A to FIG. 4C are schematic views illustrating the vicinity of the boundary between the crystalline phase and the non-crystalline phase and describing the model of the nanocrystalline alloy formation. FIG. 4A to FIG. 4C schematically illustrate the average migration distance of each of Fe, B, P, and Cu atoms, and the average migration distance of a boundary 50 between a crystalline region 14 and a non-crystalline region 16. In FIG. 4B and FIG. 4C, atoms in the crystalline region 14 are not illustrated.

As illustrated in FIG. 2A, before heating, almost the entirety of an alloy 10 is the non-crystalline region 16. As illustrated in FIG. 2B, as the alloy 10 is heated, Cu clusters 12a and 12b with a Cu concentration higher than the Cu concentration of the precursor alloy are formed in the non-crystalline region 16. The size of the Cu clusters varies, but in FIG. 2B, large Cu clusters are denoted by 12a, and small Cu clusters are denoted by 12b.

As illustrated in FIG. 2C, as the alloy 10 is further heated, iron crystalline phases with a BCC structure are formed from the surfaces of the large Cu clusters 12a of the Cu clusters, and the crystalline regions 14 formed of the crystalline phases start to grow.

FIG. 4A is an enlarged view of the vicinity of the boundary between the crystalline region 14 and the non-crystalline region 16 in FIG. 2C. The crystalline region 14 is a region formed of a crystalline phase (e.g., a crystal grain), and the non-crystalline region 16 is a region formed of a non-crystalline phase. A region 18 is a region adjacent to the crystalline region 14 in the non-crystalline region 16, and is a region where solutes such as P, B, and Cu aggregate. A region farther from the crystalline region 14 in the non-crystalline region 16 is defined as a region 17. A boundary 50 is the boundary between the crystalline region 14 and the region 18. A boundary 52 is the boundary between the regions 17 and 18, but is not a clear boundary.

First, the Fe concentration and the solute concentration in the region 17 in the early stage of the formation of the crystalline region 14 are substantially equal to the Fe concentration (e.g., 79 atomic % or greater) and the solute concentration of the non-crystalline alloy (the precursor alloy), respectively.

As indicated by arrows 30a, Fe atoms 20 in the region 18 migrate to near the boundary 50, and then, near the boundary 50, the Fe atoms 20 combine with atoms located near the surface of the crystalline region 14. This causes the boundary 50 to move to a boundary 50a as indicated by an arrow 35, and the size of the crystalline region 14 increases. The boundary 52 moves to a boundary 52a. In this case, all of the solute atoms (B atoms 22, P atoms 24, Cu atoms 26) are not solid-solved in the crystalline phase (rather, they are difficult to solid-solve), part of the solute atoms are incorporated into the crystalline region 14, but another part (the rest) of the solute atoms are discharged to the non-crystalline region 16. That is, the solutes are distributed so that the concentration of the solutes in the non-crystalline region 16 is larger between those in the crystalline region 14 and the non-crystalline region 16 (those in the regions sandwiching the boundary 50 therebetween). As a result, the solute concentration in the non-crystalline region 16 becomes greater than the solute concentration in the crystalline region 14, and therefore, the Fe concentration in the non-crystalline region 16 becomes less than the Fe concentration in the crystalline region 14. In addition, the solute concentration in the region 18 becomes greater than the solute concentration in the region 17, and therefore, the Fe concentration in the region 18 becomes lower than the Fe concentration in the region 17. In the region 18, since the concentration of each element varies, the stability of the non-crystalline region 16 decreases (the free energy increases) in response to this variation in concentration.

For example, in the non-crystalline region 16, the P atoms 24 and the Cu atoms 26 tend to get closer to each other, but the P atoms 24 and the B atoms 22 tend to get away from each other. The Cu atoms 26 and the B atoms 22 tend to get away from each other. This causes the migration rate of the B atoms 22 from the region 18 to the region 17 indicated by arrows 32 to be greater than the migration rates of the P atoms 24 and the Cu atoms 26 from the region 18 to the region 17 indicated by arrows 34 and 36. As a result, in the non-crystalline region 16, concentration variations occur for each element from the region 18 to the region 17. For example, the B concentration in the region 17 tends to be higher than the B concentration in the region 18. On the other hand, the P concentration and the Cu concentration in the region 17 tend to be lower than the P concentration and the Cu concentration in the region 18.

Additionally, in the region 18, the Fe concentration decreases with time, but the lower limit of the Fe concentration is determined by the most stable chemical composition in the region 18. In the case that the alloy 10 contains Fe, B, P, and Cu, since the P concentration tends to be high, the chemical composition of the region 18 is easily influenced by the P atoms 24. In this case, when there are three Fe atoms 20 with respect to one P atom 24, the non-crystalline phase in the region 18 tends to be stable. (That is, this composition ratio corresponds to the fact that the compound when the non-crystalline phase is crystalized tends to be Fe₃P). Therefore, the Fe concentration in the region 18 comes closer to 75 atomic % as time passes. As the crystalline region 14 increases, the Fe concentration decreases and the solute concentration increases in the region 18. This causes instability (the Fe concentration in the region 18 becomes insufficient) due to the concentration difference, at the boundary 52 between the non-crystalline phase of the region 17 and the non-crystalline phase of the region 18. This instability causes the solute atoms in the region 18 to migrate to the region 17, and the Fe atoms 20 in the region 17 to migrate to the region 18. As a result, the solute concentration in the region 17 starts to increase, and the Fe concentration in the region 17 starts to decrease.

In the above description, the alloy 10 contains only Fe, B, P, and Cu, but the same description can be applied to the case that the alloy 10 contains Si and C in addition to the above four elements, as follows.

For example, the migration rate of the solute depends on the combination of solutes. First, the interaction between two solute atoms in the non-crystalline phase is important. For example, as described above, in the non-crystalline phase, a strong attraction force acts between the Cu atom 26 and the P atom 24, but a strong repulsive force acts between the Cu atom 26 and the B atom 22. A repulsive force also acts between the C atom and the Cu atom 26 and between the Si atom and the Cu atom 26. The order of the strength of the repulsive force to the Cu atom 26 is, from strongest to weakest, the B atom 22 (strong), the C atom (medium), the Si atom (medium), the Cu atom 26 (attraction force), and the P atom 24 (attraction force).

Second, the interaction between solute atoms other than the Cu atom 26 in the non-crystalline phase is important. For example, the order of the strength of the repulsive force to the B atom 22 is, from strongest to weakest, the C atom (strong), the Si atom (strong), the Cu atom 26 (strong), the B atom 22 (weak), and the P atom 24 (weak). The order of the strength of the repulsive force to the P atom 24 is, from strongest to weakest, the Si atom (strong), the P atom 24 (medium), the C atom (medium), the B atom 22 (weak), and the Cu atom 26 (attraction force). The order of the strength of the repulsive force to the Si atom is, from strongest to weakest, the Si atom (strong), the P atom 24 (strong), the B atom 22 (strong), the C atom (strong), and the Cu atom 26 (medium). The order of the strength of the repulsive force to the C atom is, from strongest to weakest, the C atom (strong), the B atom 22 (strong), the Si atom (medium), the P atom 24 (medium), and the Cu atom 26 (medium). In addition, the order of ease of solid-solubility into the crystalline phase is, from easiest to least, the Si atom (strong), the P atom 24 (medium), the B atom 22 (weak), the C atom (weak), and the Cu atom (weak).

From these facts, in the case that the alloy 10 further contains Si, Si is more likely to be distributed in the order of the crystalline region 14, the region 18, and the region 17 because Si avoids the region containing B and P, but is easily solid-solved in the crystalline phase. In addition, in the case that the alloy 10 further contains C, C is more likely to be distributed in the order of the region 17, the region 18, and the crystalline region 14 because C avoids the region containing B and P, but is also difficult to solid-solve in the crystalline phase. In the case that the alloy 10 contains both Si and C, C is as described above, but Si is likely to be distributed in the crystalline region 14 more preferentially because Si also avoids the region containing C.

The difference between the concentration of each element in the region 17 and the concentration of each element in the region 18 caused by the formation of the crystalline region 14 results in the difference between the stability of the non-crystalline region 16 in the region 17 and the stability of the non-crystalline region 16 in the region 18 (the free energy difference). It is important to determine the chemical composition and the heat treatment conditions according to the desired properties so that each atom is distributed to the region 17, the region 18, and the crystalline region 14 via the boundaries 50 and 52 to reduce this difference in stability.

As illustrated in FIG. 3A, in the retention period 42, the crystalline region 14 further grows and becomes larger. In FIG. 4B, as the Fe concentration in the region 17 decreases and comes closer to 75 atomic %, the migration of the Fe atoms 20 from the region 17 to the region 18 indicated by an arrow 30b decreases, and the migration of the Fe atoms 20 from the region 18 to the vicinity of the boundary 50 indicated by the arrow 30a decreases. As a result, the growth of the crystalline region 14 indicated by the arrow 35 slows down (comes close to saturation).

As illustrated in FIG. 3B, in the retention period 42, the growth of the crystalline region 14 saturates. In FIG. 4C, the B concentration in the region 17 becomes higher than the B concentration in the region 18, and the P concentration and the Cu concentration in the region 17 become lower than the P concentration and the Cu concentration in the region 18. Since the B concentration tends to be high in the region 17, the chemical composition of the region 17 is easily influenced by the B atoms 22. In this case, when there are two Fe atoms 20 with respect to one B atom 22, the non-crystalline phase of the region 17 tends to be stable (i.e., this composition ratio corresponds to the fact that the compound when the non-crystalline phase is crystalized tends to become Fe₂B). Therefore, the Fe concentration in the region 18 becomes around 75 atomic %, and the Fe concentration in the region 17 becomes less than 75 atomic %. For example, the Fe concentration in the region 17 is between 66 atomic % and 75 atomic %. The migration of the B atoms 22 from the region 18 to the region 17 is almost eliminated, and the migration of the Fe atoms 20 from the region 17 to the region 18 and the migration of the Fe atoms 20 from the region 18 to the vicinity of the boundary 50 are also almost eliminated. This results in saturation of the growth of the crystalline region 14. The final concentration gradient of each element in each of the crystalline region 14 and the non-crystalline region 16 is determined by the chemical composition of the alloy 10 and the heat treatment conditions.

As illustrated in FIG. 3C, during the cooling period 44, as the temperature decreases, Cu atoms are less likely to be solid-solved in the non-crystalline region 16. This causes the Cu atoms to form a Cu cluster 12c in the non-crystalline region 16. The above heat treatment process causes the crystalline regions 14 surrounded by the non-crystalline region 16 to be formed.

According to the above model for the nanocrystalline alloy formation, in the early stage (for example, the heating period 40) of the formation of the nanocrystalline alloy, the density of the large Cu clusters 12a is considered to affect the size of the crystalline region 14. A higher density of the large Cu clusters 12a results in a higher density of the crystalline region 14, and thereby, the size of the crystalline region 14 is considered to become smaller.

The Cu clusters 12a, 12b, and 12c may inhibit the migration of the magnetic domain wall, and may increase the coercivity. Thus, it is preferable that the density of the Cu cluster 12a, which is a product nucleus of the crystalline region 14, is high, but the total number (i.e., the total number density) of the Cu clusters 12a, 12b, and 12c is small. In addition, as the concentration of Cu that is solid-solved in the crystalline region 14 and the non-crystalline region 16 increases, the quantum-mechanical action between the Cu atom and the Fe atom increases. This decreases the saturation magnetic flux density. Therefore, the concentration of solid solved Cu is preferably low.

The formation of the Cu cluster is considered to be related to the mechanism of spinodal decomposition. In the early stage of spinodal decomposition, the Fe-rich non-crystalline phase and the Cu-rich non-crystalline phase are formed as a periodic structure with wavelength λm. Thereafter, the Cu concentration in the Cu-rich non-crystalline phase or the size of the Cu-rich non-crystalline phase increases while the wavelength λm is maintained, and a Cu cluster is formed. When spinodal decomposition starts at low temperature, the wavelength λm is small, and when spinodal decomposition starts at high temperature, the wavelength λm is large. Therefore, it is considered that when the heating rate 45 is large, the total number of Cu clusters at the point in time at which the crystalline region 14 starts to be formed becomes smaller, and the Cu cluster becomes larger. It is considered that when the heating rate 45 is small, the total number of Cu clusters at the point in time at which the crystalline region 14 starts to be formed becomes larger, and the Cu cluster becomes smaller. Therefore, it is considered that when the heating rate 45 is large, the large Cu clusters can be used as nucleation sites, and the size of the crystalline region 14 becomes smaller, and the coercivity can be lowered.

During the heat treatment, the Cu cluster contains crystals having a body-centered cubic (BCC) structure, crystals having a face-centered cubic (FCC) structure, and Cu-rich non-crystalline phases. In the case that the Cu-rich non-crystalline phase becomes the nucleation site of the crystalline region 14, the Cu concentration in the Cu-rich non-crystalline phase increases while the B concentration in the Cu-rich non-crystalline phase decreases significantly, and the Fe concentration decreases. Thus, a region where the B concentration is low and the Fe concentration is relatively high is formed in the vicinity of the interface between the Cu-rich non-crystalline phase and the Fe-rich non-crystalline phase. Such regions are more likely to be formed as the size of the Cu-rich non-crystalline phase increases. In addition, in such regions, the stability of the non-crystalline phase is low, and therefore, the non-crystalline phase changes to the crystalline phase. As a result, the crystalline region 14 starts to form from the vicinity of the interface between the Cu-rich non-crystalline phase and the Fe-rich non-crystalline phase. This Cu-rich non-crystalline phase can also slow down the growth of the crystalline region 14.

When the crystalline phase (Cu) with a face-centered cubic (FCC) structure becomes the nucleation site of the crystalline region 14, the crystalline phase (Fe) with a BCC structure starts to form from the surface of the crystalline phase (Cu) with an FCC structure because the consistency between the crystalline phase (Cu) with an FCC structure and the crystalline phase (Fe) with a BCC structure is high. To proceed the crystallization by this high consistency, a certain size or greater of the crystalline phase (Cu) with an FCC structure is required. This crystalline phase (Cu) with an FCC structure is formed when the Cu-rich non-crystalline phase surrounded by the Fe-rich non-crystalline phase is crystallized and when solid-solved Cu in the Fe-rich non-crystalline phase aggregates and crystallizes. On the other hand, the crystalline phase (Cu) with a BCC structure is formed when the Cu-rich non-crystalline phase surrounded by the crystalline phase (Fe) with a BCC structure crystalizes and when solid-solved Cu in the crystalline phase (Fe) with a BCC structure aggregates and crystalizes.

In the middle stage of the formation of the nanocrystalline alloy (for example, during the retention period 42), it is considered that the P concentration and the B concentration affect the size of the crystalline region 14. As illustrated in FIG. 4A to FIG. 4C, when the B concentration is high, many B atoms 22 migrate from the region 18 to region 17, and therefore, many Fe atoms 20 migrate from the region 17 to the region 18. Thus, the Fe atoms 20 are supplied to the boundary 50, and the crystalline region 14 becomes larger. By contrast, when the P concentration is high, the number of the Fe atoms 20 that migrate from the region 17 to the region 18 is small because the P atoms 24 are less likely to migrate from the region 18 to the region 17 than the B atoms 22. Therefore, the number of the Fe atoms 20 that are supplied to the boundary 50 is small, and the size of the crystalline region 14 is less likely to become larger.

Additionally, when the P concentration is high, the migration rates of the P atoms and the Cu atoms in the region 18 to the region 18 decrease because attraction force acts between the P atom and the Cu atom (the free energy decreases). Therefore, the rate at which the size of the crystalline region 14 increases is reduced. Thus, the growth rate of the crystalline region 14 can be reduced, and thereby, the time for nucleation is increased and the number (the number density) of the crystalline regions 14 can be increased, and heat generation associated with crystallization per unit time is reduced and the temperature rise and temperature irregularity in the alloy 10 can be prevented. As a result, the size of the crystalline region 14 can be reduced.

As described above, it is considered that the size of the crystalline region 14 is reduced when P concentration/B concentration is high. On the other hand, when the B concentration is high, the Cu cluster tends to become the crystalline phase (Cu) with an FCC structure because repulsive force acts between the B atom and the Cu atom (the free energy increases). Since this crystalline phase (Cu) with an FCC structure hardly reduces the growth rate of the crystalline region 14 compared to the Cu-rich non-crystalline phase (the crystalline region 14 can grow while incorporating the crystalline phase (Cu) with an FCC structure), the size of the crystalline region 14 is less likely to reduce.

Based on the above ideas, a description will be given of an embodiment.

### Chemical Composition

The average atomic concentrations of Fe, P, B, and Cu in the whole alloy are represented by CFe, CP, CB, and CCu, respectively. CFe, CP, CB, and CCu correspond to the chemical composition of Fe, P, B, and Cu in the whole alloy. This chemical composition basically matches the chemical composition of the precursor alloy.

In the present embodiment, the alloy contains Fe, B, P, and Cu. The average Fe concentration CFe in the whole alloy is 79 atomic % or greater. By adjusting the Fe concentration in the alloy to be high and the concentration of metalloids to be low, the saturation magnetic flux density can be made to be high. Therefore, CFe is preferably 80 atomic % or greater, more preferably 82 atomic % or 83 atomic % or greater, further preferably 84 atomic % or greater. The average B concentration CB in the whole alloy is preferably 12 atomic % or less, more preferably 10 atomic % or less, further preferably 9.0 atomic % or less. The average P concentration CP is preferably 12 atomic % or less, more preferably 10 atomic % or less. The average concentration of metalloids (B, P, C, and Si) in the whole alloy is preferably 15 atomic % or less, more preferably 13 atomic % or less.

By adjusting the concentration of metalloids ((B, P, C, and Si) such as P and B in the alloy to be high, the non-crystalline region 16 can be provided between the crystalline regions 14. This can reduce the coercivity. Therefore, CFe is preferably 88 atomic % or less, more preferably 87 atomic % or less, further preferably 86 atomic % or less. Each of CB and CP is preferably 2.0 atomic % or greater, more preferably 3.0 atomic % or greater.

As illustrated in FIG. 4A to FIG. 4C, to reduce the size of the crystalline region 14, B concentration/P concentration is preferably reduced. From this point of view, the value CB/CP obtained by dividing the average B atomic concentration by the average P atomic concentration in the whole alloy is preferably 3.5 or less, more preferably 3.2 or less. If the B concentration is too low, the total amount of the crystalline regions 14 is reduced, resulting in lower saturation magnetic flux density. From this point of view, CB/CP is preferably 1.5 or greater, more preferably 2.0 or greater.

To form the crystalline region 14, the density of the large Cu clusters 12a in FIG. 2B is preferably high. From this point of view, the average Cu concentration CCu in the whole alloy is preferably 0.4 atomic % or greater, more preferably 0.5 atomic % or greater, further preferably 0.6 atomic % or greater. As the Cu concentration increases, more Cu clusters 12a, 12b, and 12c are formed in the crystalline regions 14 and the non-crystalline region 16 in FIG. 3C. The Cu clusters 12a, 12b, and 12c inhibit the migration of the magnetic domain wall. Further, if the Cu concentration is too high, the density of the Cu clusters 12a does not increase so much because the wavelength λm becomes smaller. In addition, if Cu is solid-solved in the crystalline regions 14 and the non-crystalline region 16, the quantum-mechanical action between the Fe atom and the Cu atom increases. This reduces the saturation magnetic flux density. From this point of view, CCu is preferably 1.4 atomic % or less, more preferably 1.2 atomic % or less, further preferably 1.0 atomic % or less or 0.9 atomic % or less.

The alloy may contain Si. The oxidation resistance of the alloy is improved by containing of Si in the alloy. The second crystallization starting temperature Tx2 can be increased by containing of Si in the alloy. The alloy may contain C. The saturation magnetic flux density can be improved by containing of C, which is a small atom, in the alloy. To achieve these effects, the sum of the average Si concentration CSi and the average C concentration CC in the whole alloy may be 0 atomic % or greater, and is preferably 0.5 atomic % or greater. CSi may be 0 atomic % or greater, and is preferably 0.2 atomic % or greater, more preferably 0.5 atomic % or greater. CC may be 0 atomic % or greater, and is preferably 0.2 atomic % or greater, more preferably 0.5 atomic % or greater, further preferably 1.0 atomic % or greater. If the alloy contains Si and C much, it becomes difficult to control the formation of the crystalline regions 14 by P and B described in the above model. Therefore, the sum of CSi and CC is preferably 3.0 atomic % or less, more preferably 2.0 atomic % or less, further preferably 1.0 atomic % or less. Each of CSi and CC is preferably 3.0 atomic % or less, more preferably 2.0 atomic % or less, further preferably 1.0 atomic % or less. When Si and C are considered impurities, the sum of CSi and CC is to be 0.1 atomic % or less.

The alloy may contain at least one element of, for example, Ti, Al, Zr, Hf, Nb, Ta, Mo, W, Cr, V, Co, Ni, Mn, Ag, Zn, Sn, Pb, As, Sb, Bi, S, N, O and rare-earth elements, as impurities. If the alloy contains these elements largely, it may become difficult to control the formation of the crystalline regions 14 by P and B described in the above model. In addition, for example, Ti and Al form precipitates such as oxides and nitrides, and the precipitates behave as heterogeneous nucleation sites, resulting in increase in the size of the crystalline region 14. For example, Cr, Mn, V, Mo, Nb, Ti, and W have attraction force to P in the non-crystalline region 16, and therefore, the advantages that P provides to the nanocrystalline structure, described above are easily lost. Therefore, their high concentrations make the formation of the crystalline regions 14 and the non-crystalline region 16 unstable. Therefore, the sum of the average concentrations of elements other than Fe, P, B, Cu, Si, and C in the whole alloy is preferably 0 atomic % or greater and 0.3 atomic % or less, more preferably 0 atomic % or greater and 0.1 atomic % or less. The average concentration of each of the elements other than Fe, P, B, Cu, Si, and C in the whole alloy is preferably 0 atomic % or greater and 0.10 atomic % or less, more preferably 0 atomic % or greater and 0.02 atomic % or less.

### Evaluation Method

Three dimensional atom probe (3DAP) is used to evaluate alloys. Various software can be used for atom probe tomography analysis, and, for example, IVAS (registered trademark) can be used. In atom probe tomography analysis, a 3D map is divided into multiple sections with 1.0 nm on a side (cubes: voxels), and the concentration of each element in each section is calculated.

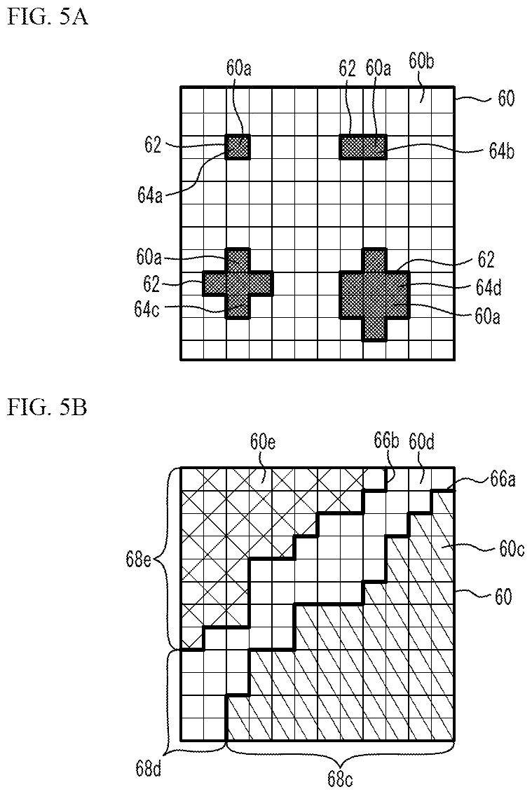

FIG. 5A is a diagram for describing an evaluation method of the Cu cluster, and FIG. 5B is a diagram for describing a method of setting the region of the Fe concentration and an evaluation method of proxigrams. In atom probe tomography, the location and the concentration of each atom are analyzed in three dimensions, but a description will be given in two dimensions in FIG. 5A and FIG. 5B.

Used to analyze Cu clusters is cluster analysis (Cluster Analysis, Cluster Count Distribution Analysis, Cluster Size Distribution Analysis) in IVAS (registered trademark) or the similar function in equivalent software (methods that yield the same results as the cluster analysis in IVAS (registered trademark)). This cluster analysis is the following function, in brief.

As illustrated in FIG. 5A, among multiple regions 60 (cubes) with 1.0 nm on a side, regions where the Cu concentration is equal to or greater than the threshold value (for example, 6.0 atomic %) are extracted. The extracted regions where the Cu concentration is equal to or greater than the threshold value are regions 60a (cross-hatched regions), the regions where the Cu concentration is less than the threshold value are regions 60b (white regions). The boundary interface between the region 60a and the region 60b is a boundary 62 (a bold line). The regions 60a surrounded by the boundaries 62 are defined as Cu clusters 64a to 64d. The volume of each of the Cu clusters 64a, 64b, 64c, and 64d is calculated by the volume surrounded by the corresponding boundary 62. The diameter (a spherical equivalent diameter) of each of the Cu clusters 64a to 64d is calculated as the diameter when the Cu clusters 64a to 64d are spheres with the same volume.

For the concentration of each element in the region where the concentration of the particular element is within a particular range, used is isoconcentration surface analysis in IVAS (registered trademark) or the similar function of equivalent software (methods that yield the same results as isoconcentration surface analysis in IVAS (registered trademark)). The concentration determination function by the isoconcentration surface analysis is the following function in brief. As illustrated in FIG. 5B, among multiple regions 60, the region 60 where the Fe concentration is 80 atomic % or less is defined as a region 60c, the region 60 where the Fe concentration is 90 atomic % or greater is defined as a region 60e, and the region 60 where the Fe concentration is greater than 80 atomic % and less than 90 atomic % is defined as a region 60d. The boundary interface between the region 60c and the region 60d is a boundary 66a. The boundary interface between the region 60d and the region 60e is a boundary 66b. The boundaries 66a and 66b are isoconcentration surfaces of 80 atomic % and 90 atomic %, respectively. A region 68c composed of multiple regions 60c is considered to be mainly the non-crystalline region 16. A region 68d composed of multiple regions 60d may contain information about both the non-crystalline region 16 and the crystalline region 14. This region 68d is considered to contain, for example, the region 18. A region 68e composed of multiple regions 60e is considered to be mainly the crystalline region 14.

The relationship between the distance from the specified isoconcentration surface of the specified element and the concentration of each element is called proxigram. For this proxigram, used is the proxigram generation function (Proxigrams) in IVAS (registered trademark) or a similar function of equivalent software (methods that yield the same results as the isoconcentration surface analysis in IVAS (registered trademark)). This proxigram generation function based on the isoconcentration surface analysis is the following function in brief. To obtain the proxigram with respect to the boundary interface with an Fe concentration of 80 atomic % as the specified isoconcentration surface, the distance between the region 60 and the specified isoconcentration surface (the boundary 66a) is calculated for each region 60, the data on the concentration of each element in each region for each distance category is tabulated and averaged to determine the relationship between the distance and the concentration of each element. The distance in the direction from the boundary 66a to the region 60e (the direction in which the Fe concentration increases) is positive distance, and the distance in the direction from the boundary 66a to the regions 60d and 60c (the direction in which the Fe concentration decreases) is negative distance.

### Distribution of Cu Clusters

The density of the Cu clusters when a cluster of the regions 60a with a Cu concentration of N atomic % or greater among the regions 60 each having 1.0 nm on a side in the atom probe tomography is determined to be the Cu clusters 64a to 64d, is represented by CuN. That is, the threshold Cu concentration to determine the Cu cluster is N atomic %. For example, when N atomic % is 6.0 atomic %, the density of the Cu clusters is expressed by Cu6.

### Distribution 1 of Cu Clusters

Cu6 is preferably 0.20×10²⁴/m³ (the number of clusters per 1 m³) or greater. The Cu cluster with a threshold Cu concentration of 6.0 atomic % is considered to be a large cluster or a cluster with a high number density of Cu atoms. In alloys with a high number density of Cu clusters, the density of the larger-size Cu clusters 12a tends to be high in FIG. 3B. Therefore, the size of the crystalline region 14 is small, and the coercivity is low. In alloys with a large number of the large Cu clusters 12a, the Cu concentration in the non-crystalline region 16 is low. Thus, the number of the Cu clusters 12c that did not contribute to nucleation in FIG. 4C is small, and the coercivity is low. In addition, since the concentration of solid-solved Cu is low, the saturation magnetic flux density is high.

Cu6 is preferably 0.25×10²⁴/m³ or greater, more preferably 0.28×10²⁴/m³ or greater. To reduce the total number of Cu clusters, Cu6 is preferably 5.0×10²⁴/m³ or less, more preferably 2.0×10²⁴/m³ or less. The number density of Cu clusters can be controlled by the heating rate 45, the retention temperature T2 immediately after heating, and the cooling rate 46, in the heat treatment.

### Distribution 2 of Cu Clusters

The value obtained by dividing Cu1.5 by Cu6 is preferably 15 or less. The Cu clusters when the threshold Cu concentration is 1.5 are considered to include large and small Cu clusters. That is, Cu1.5 is considered to correspond to the number density of large and small Cu clusters in the whole alloy. Therefore, since the alloy with Cu1.5/Cu6 of 15 or less has high Cu6, the density of the Cu clusters 12a in FIG. 2B is high, and the size of the crystalline region 14 is small. In addition, the total number of Cu clusters in this alloy is small, and therefore, the migration of the magnetic domain wall is less likely to be inhibited. Therefore, this alloy has low coercivity.

Cu1.5/Cu6 is preferably 12 or less, more preferably 10 or less. Cu1.5/Cu6 is, for example, 1.0 or greater. Cu1.5/Cu6 can be controlled by the heating rate 45, the retention temperature T2 immediately after heating, the length of the retention period 42, and the cooling rate 46, in the heat treatment.

### Distribution 3 of Cu Clusters

The average spherical equivalent diameter Cuφ2 of the Cu clusters when the region with a Cu concentration of 2.3 atomic % or greater in the regions with an Fe concentration of 80 atomic % or less is determined to be a Cu cluster is preferably 3.0 nm or greater. In this alloy, the size of the Cu cluster 12c in the non-crystalline region 16 in FIG. 3C is large. Thus, the total number of Cu clusters in the non-crystalline region 16 is small. Therefore, the migration of the magnetic domain wall is less likely to be inhibited, and the coercivity tends to be small. In addition, the amount of Cu being solid-solved in the non-crystalline region 16 is small, and the saturation magnetic flux density is high.

Cuφ2 is preferably 3.1 nm or greater, more preferably 3.2 nm or greater. Cuφ2 is preferably 10 nm or less, more preferably 5.0 nm or less. Cuφ2 can be controlled by the heating rate 45, the retention temperature T2 immediately after heating, the length of the retention period 42, and the cooling rate 46, in the heat treatment.

### Distribution 4 of Cu Clusters

The value Cu1.5/CCu obtained by dividing Cu1.5 by CCu is preferably 3.0×10²⁴/m³/atomic % or less. In the alloy with small Cu1.5/CCu, the total number of Cu clusters is small, and there are many large Cu clusters. Thus, the coercivity is low.

Cu1.5/CCu is preferably 2.8×10²⁴/m³/atomic % or less, more preferably 2.5×10²⁴/m³/atomic % or less. If Cu1.5/CCu is too small, large Cu clusters are not formed, the size of the crystalline region 14 becomes larger, and the coercivity becomes higher. Thus, Cu1.5/CCu is preferably 1.0×10²⁴/m³/atomic % or greater, more preferably 1.5×10²⁴/m³/atomic % or greater. Cu1.5/CCu can be controlled by the heating rate 45, the retention temperature T2 immediately after heating, and the cooling rate 46, in the heat treatment.

### Distribution 5 of Cu Clusters

The average spherical equivalent diameter Cuφ1 of the Cu clusters when the region with a Cu concentration of 2.3 atomic % or greater in the regions with an Fe concentration of 80 atomic % or greater is determined to be a Cu cluster is preferably 3.0 nm or greater. In the alloy in which the Cu clusters 12a and 12c in the crystalline region 14 and the region 18 are large, the total number of the Cu clusters is small. Thus, the coercivity is low. In addition, there is less Cu being solid-solved in the non-crystalline region 16. Therefore, the saturation magnetic flux density is high.

Cuφ1 is preferably 3.1 nm or greater, more preferably 3.2 nm or greater. Cuφ1 is preferably 10 nm or less, more preferably 5.0 nm or less. Cuφ1 can be controlled by the heating rate 45 and the retention temperature T2 immediately after heating, in the heat treatment.

### Distribution of the Cu Concentration

The average Cu concentration in the regions 60c with an Fe concentration of 80 atomic % or less is represented by C8Cu, and the average Cu concentration in the regions 60e with an Fe concentration of 90 atomic % or greater is represented by C9Cu. The region with an Fe concentration of 80 atomic % or greater is mainly the non-crystalline region 16, and the region with an Fe concentration of 90 atomic % or greater is mainly the crystalline region 14.

### Distribution 1 of the Cu Concentration

The value C8Cu/C9Cu obtained by dividing the average Cu atomic concentration C8Cu in the regions 60c with an Fe concentration of 80 atomic % or less by the average Cu atomic concentration C9Cu in the regions 60e with an Fe concentration of 90 atomic % or greater is preferably 1.8 or greater. After the nanocrystalline alloy is formed, the crystalline region 14 has larger magnetic anisotropy than the non-crystalline region 16. In the crystalline phase with large magnetic anisotropy, the width of the magnetic domain wall is small. Thus, the effect of Cu clusters inhibiting the migration of the magnetic domain wall is greater in the crystalline region 14 than in the amorphous region 16. When C9Cu is low, the number of Cu clusters in the crystalline region 14 is small. Thus, in the alloy with large C8Cu/C9Cu, the increase in the coercivity due to the prevention of the migration of the magnetic domain wall by the Cu clusters is reduced, and thereby, the coercivity is low. C8Cu/C9Cu is preferably 2.0 or greater, more preferably 2.1 or greater. If C9Cu is too low, the density of the Cu cluster 12a becomes small in the early stage of the nanocrystalline alloy formation in FIG. 3B, and the coercivity decreases. Therefore, C8Cu/C9Cu is preferably 5.0 or less, more preferably 3.0 or less. C8Cu/C9Cu can be controlled by the heating rate 45, the retention temperature T2 immediately after heating, the length of the retention period 42, and the cooling rate 46, in the heat treatment.

### Distribution 2 of the Cu Concentration

In the proxigram with respect to the boundary 66a with an Fe concentration of 80 atomic % as the specified isoconcentration surface, the maximum value Cumax of the Cu concentration is preferably 1.25 atomic % or greater within the range of ±5.0 nm from the boundary 66a. As illustrated in FIG. 4A to FIG. 4C, when the Cu concentration in the region 18 is high, the P concentration in the region 18 is high, and the migration rate of the Fe atoms 20 migrating to the boundary 50 decreases. This makes it difficult for the size of the crystalline region 14 to increase. Therefore, the alloy with large Cumax has low coercivity.

Cumax is preferably 1.27 atomic % or greater, more preferably 1.29 atomic % or greater. Too high Cumax makes the total number of Cu clusters large, resulting in high coercivity. Therefore, Cumax is preferably 2.0 atomic % or less, more preferably 1.5 atomic % or less. Cumax can be controlled by the heating rate 45, the retention temperature T2 immediately after heating, the length of the retention period 42, and the cooling rate 46, in the heat treatment.

### Distribution of the Fe Concentration

The average Fe concentration in the regions 60c with an Fe concentration of 80 atomic % or less is represented by C8Fe, and the average Fe concentration in the regions 60e with an Fe concentration of 90 atomic % or greater is represented by C9Fe.

### Distribution 1 of the Fe Concentration

The average Fe concentration C8Fe in the regions 60c with an Fe concentration of 80 atomic % or less is preferably 74.5 atomic % or less. The alloy with a low Fe concentration in the non-crystalline region 16 has a high proportion of the crystalline region 14 within the alloy. Therefore, the saturation magnetic flux density is high. As illustrated in FIG. 4C, the B atoms 22 migrate to the region 17, the Fe atoms 20 goes through the region 18 to combine with elements on the surface of the crystalline region 14 at the boundary 50, and the crystalline region 14 increases. In this case, the Fe concentration in the region 17 becomes less than 75 atomic %. Therefore, the alloy with low C8Fe contains B appropriately so that the total amount of the crystalline regions 14 is large.

C8Fe is preferably 74.0 atomic % or less, more preferably 72.5 atomic % or less. On the other hand, if the Fe concentration in the non-crystalline region 16 decreases too much, the saturation magnetic flux density of the non-crystalline region 16 decreases or the magnetism is lost. This results in decrease in saturation magnetic flux density of the alloy. Therefore, C8Fe is preferably 50 atomic % or greater, more preferably 66 atomic % or greater or 67 atomic % or greater, further preferably 70 atomic % or greater. C8Fe can be controlled by the heating rate 45, the retention temperature T2 immediately after heating, and the length of the retention period 42, in the heat treatment.

### Distribution 2 of the Fe Concentration

In a proxigram with respect to the boundary 66a with an Fe concentration of 80 atomic % as the specified isoconcentration surface, when the direction approaching the crystalline region 14 (the direction in which the Fe concentration increases) is defined as positive, the slope ΔFe of the Fe concentration through the position of −2.0 nm from the boundary 66a and the position of −4.0 nm from the boundary 66a is preferably 0.03 atomic %/nm or greater. The alloy with large ΔFe has small fluctuations in the energy of the magnetic domain wall in the non-crystalline region 16 (particularly, in the region 18) while having a high proportion of the crystalline region 14. Therefore, the saturation magnetic flux density is high and the coercivity is low.

The ΔFe is preferably 0.05 atomic %/nm or greater, more preferably 0.10 atomic %/nm or greater. If ΔFe is too large, the elemental distribution in the non-crystalline region 16 may vary with time due to diffusion of atoms, and the soft magnetic properties may degrade. Therefore, ΔFe is preferably 1.0 atomic %/nm or less, more preferably 0.5 atomic %/nm or less. The ΔFe can be controlled by the heating rate 45, the retention temperature T2 immediately after heating, the length of the retention period 42, and the cooling rate 46, in the heat treatment.

### Distribution of the B Concentration

The average B concentration in the regions 60c with an Fe concentration of 80 atomic % or less is represented by C8B, and the average B concentration in the regions 60e with an Fe concentration of 90 atomic % or greater is represented by C9B.

### Distribution 1 of the B Concentration

The value C9B/√CB obtained by dividing the average B atomic concentration C9B in the regions 60e with an Fe concentration of 90 atomic % or greater by the square root of the average B atomic concentration CB in the whole alloy is preferably 0.56 atomic %^{0.5} or greater. The incorporation of B atoms into the crystalline region 14 decreases the total amount of B in the non-crystalline region 16. This increases the proportion of the crystalline region 14 in the alloy. In addition, as described in FIG. 4A to FIG. 4C, since the B atoms 22 in the region 18 decrease, the crystalline region 14 becomes smaller. Therefore, the alloy with large C9B/√CB has high saturation magnetic flux density and low coercivity.

C9B/√CB is preferably 0.58 atomic %^{0.5} or greater. C9B/√CB is preferably 1.0 atomic %^{0.5} or less, more preferably 0.8 atomic %^{0.5} or less. C9B/√CB can be controlled by the heating rate 45, the retention temperature T2 immediately after heating, and the length of the retention period 42, in the heat treatment.

### Distribution of the P Concentration

The average P concentration in the regions 60c with an Fe concentration of 80 atomic % or less is represented by C8P, and the average P concentration in the regions 60e with an Fe concentration of 90 atomic % or greater is represented by C9P.

### Distribution 1 of the P Concentration

The value C9P/CP obtained by dividing the average P atomic concentration C9P in the regions 60e with an Fe concentration of 90 atomic % or greater by the average P atomic concentration CP in the whole alloy is preferably 0.36 or less. When the P concentration in the crystalline region 14 is low, the P atoms 24 aggregate in the region 18. Therefore, as described in FIG. 4A to FIG. 4C, the P concentration in the region 18 becomes higher, and the size of each crystalline region 14 becomes smaller. Therefore, the alloy with small C9P/CP has low coercivity.

C9P/CP is, for example, 0.5 or less. C9P/CP can be controlled by the heating rate 45, the retention temperature T2 immediately after heating, and the length of the retention period 42, in the heat treatment.

### Distribution 2 of the P Concentration

The value C8P/CP obtained by dividing the average P atomic concentration C8P in the regions 60c with an Fe concentration of 80 atomic % or less by the average P atomic concentration CP in the whole alloy is preferably 1.6 or greater. When the P concentration in the non-crystalline region 16 is high, the P atoms 24 aggregate in the region 18. Therefore, as described in FIG. 4A to FIG. 4C, the P concentration in the region 18 becomes higher, and the size of each crystalline region 14 becomes smaller. Therefore, the alloy with large C8P/CP has low coercivity.

C8P/CP is preferably 1.7 or greater. C8P/CP is, for example, 2.0 or less. C8P/CP can be controlled by the heating rate 45, the retention temperature T2 immediately after heating, and the length of the retention period 42, in the heat treatment.

### Distribution 1 of P Concentration/B Concentration

In a proxigram with respect to the boundary 66a with an Fe concentration of 80 atomic % as the specified isoconcentration surface, P atomic concentration/B atomic concentration P/B preferably has a local minimum value and a local maximum value within a range of ±5.0 nm from the boundary 66a. As described in FIG. 4A to FIG. 4C, as the B atoms 22 preferentially migrate to the region 17 and the P atoms 24 preferentially stay in the region 18, P/B has a local maximum within the region 18, and a local minimum near the boundary 50. This reduces the size of each crystalline region 14, reducing the coercivity. Therefore, the alloy with P/B having a local maximum value and a local minimum value in the proxigram has small coercivity. The local maximum value and the local minimum value of P/B within a range of ±5.0 nm from the boundary 66a can be controlled by the heating rate 45, the retention temperature T2 immediately after heating, and the length of the retention period 42, in the heat treatment.

### Distribution 2 of P Concentration/B Concentration

In a proxigram with respect to the boundary 66a with an Fe concentration of 80 atomic % as the specified isoconcentration surface, the local maximum value P/Bmax of P atomic concentration/B atomic concentration P/B is 1.0 or greater within a range of ±3.0 nm from the boundary 66a. In the alloy with large P/Bmax, the P atoms aggregate in the region 18. Therefore, as described in FIG. 4A to FIG. 4C, the size of each crystalline region 14 is small, and the coercivity is low.

P/Bmax is preferably 1.5 or greater, more preferably 2.0 or greater. If P/Bmax is too high, the magnetism near the region 18 decreases, and the saturation magnetic flux density of the alloy decreases and the coercivity increases. Therefore, P/Bmax is preferably 10 or less, more preferably 5.0 or less. P/Bmax can be controlled by the heating rate 45, the retention temperature T2 immediately after heating, and the length of the retention period 42, in the heat treatment,

### Distribution 3 of P Concentration/B Concentration

In a proxigram with respect to the boundary 66a with an Fe concentration of 80 atomic % as the specified isoconcentration surface, the value (P/Bmax)/(CP/CB) obtained by dividing the local maximum value P/Bmax of P atomic concentration/B atomic concentration P/B within a range of ±3.0 nm from the boundary 66a by average P atomic concentration/average B atomic concentration CP/CB is preferably 1.0 or greater. In the alloy with large (P/Bmax)/(CP/CB), the P atoms are aggregated in the region 18, and therefore, the size of each crystalline region 14 is small, and the coercivity is low.

(P/Bmax)/(CP/CB) is preferably 1.1 or greater, more preferably 1.2 or greater. If P/Bmax is too high, the magnetism near the region 18 decreases, and the saturation magnetic flux density of the alloy decreases, and the coercivity increases. Therefore, (P/Bmax)/(CP/CB) is preferably 5.0 or less, more preferably 2.0 or less. (P/Bmax)/(CP/CB) can be controlled by the heating rate 45, the retention temperature T2 immediately after heating, and the length of the retention period 42, in the heat treatment.

### Size of the Crystalline Region

To make the coercivity low, the average of the spherical equivalent diameters of the crystalline regions 14 is preferably 50 nm or less, more preferably 30 nm or less. The average of the spherical equivalent diameters of the crystalline regions 14 may be 5.0 nm or greater.

### Manufacturing Method

The following describes a manufacturing method of the nanocrystalline alloy. The manufacturing method of the alloy in accordance with the embodiment is not limited to the method described below.

### Manufacturing Method of Non-crystalline Alloy

The single-roll method is used to manufacture non-crystalline alloys. The conditions of the roll diameter and the number of rotations for the single-roll method can be freely selected. The single-roll method is suitable for the manufacture of the non-crystalline alloy because of its ease of rapid cooling. The cooling rate of the melted alloy for manufacturing the non-crystalline alloy is preferably, for example, 10⁴° C./sec or greater, more preferably 10⁶° C./sec or greater. Methods other than the single-roll method, which include the period within which the cooling rate is 10⁴° C./sec, may be used. For the manufacture of the non-crystalline alloy, for example, the water atomizing method or the atomizing method described in Japanese Patent No. 6533352 may be used.

### Manufacturing Method of Nanocrystalline Alloy

Nanocrystalline alloys are obtained by heat treatment of non-crystalline alloys. In the manufacture of nanocrystalline alloys, the temperature history in the heat treatment affects the nanostructure of the nanocrystalline alloy. For example, in the heat treatment illustrated in FIG. 1, mainly, the heating rate 45, the retention temperature T2, the length of the retention period 42, and the cooling rate 46 affect the nanostructure of the nanocrystalline alloy.

### Heating Rate

When the heating rate 45 is large, the temperature range where small Cu clusters are formed can be avoided, and therefore, a large number of large Cu clusters are likely to be formed in the early stage of crystallization. Thus, the size of each crystalline region 14 becomes small. In addition, non-equilibrium reactions are more likely to proceed, and the concentrations of P, B, and Cu, etc. within the crystalline region 14 increase. Thus, the total amount of the crystalline regions 14 increases, and the saturation magnetic flux density increases. Furthermore, as described in FIG. 4A to FIG. 4C, P and Cu aggregate in the region 18 near the crystalline region 14, and as a result, the growth of the crystalline region 14 is suppressed, and the size of the crystalline region 14 decreases. Thus, the coercivity decreases. In the temperature range from 200° C. to the retention temperature T2, the average heating rate ΔT is preferably 360° C./min or greater, more preferably 400° C./min or greater. In this temperature range, it is more preferable if the average heating rate, calculated with 10° C.-increments, satisfies the same condition.

To decrease the coercivity, P concentration CP/B concentration CB is preferably large. This is because it is considered that as the B concentration increases, small Cu clusters are more likely to be formed. Thus, to cancel the miniaturization of Cu clusters associated with this increase in the B concentration, (CP/CB×(ΔT+20)) using CP/CB and ΔT is preferably 40° C./min or greater, more preferably 50° C./min or greater, further preferably 100° C./min or greater. In this temperature range, it is further preferable if (CP/CB×(ΔT+20)) calculated with 10° C.-increments satisfies the same condition.

### Length of the Retention Period

The length of the retention period 42 is preferably the duration with which it can be determined that crystallization has sufficiently progressed. To determine that crystallization has sufficiently progressed, it is checked that a first peak corresponding to the first crystallization starting temperature Tx1 cannot be observed or has become very small (for example, the calorific value has become equal to or less than 1/100 of the total calorific value of the first peak) in a curve (a DSC curve) obtained by differential scanning calorimetry (DSC) by heating the nanocrystalline alloy to approximately 650° C. at a constant heating rate of 40° C./min.

As crystallization (crystallization at the first peak) approaches 100%, the crystallization rate becomes very slow, and it may be impossible to determine whether crystallization has progressed sufficiently, by the DSC. Therefore, the length of the retention period is preferably set to be longer than expected from the result of the DSC. For example, the length of the retention period is preferably 0.5 minutes or greater, further preferably 5.0 minutes or greater. The saturation magnetic flux density can be increased by sufficient crystallization. If the retention period is too long, the gradient of the concentration distribution of the solute elements in the non-crystalline phase may become gradual because of atomic diffusion. Thus, the length of the retention period is preferably 60 minutes or less, more preferably 30 minutes or less.

### Retention Temperature

The maximum temperature Tmax of the retention temperature T2 is preferably equal to or greater than the first crystallization starting temperature Tx1 −20° C., and is equal to or less than the second crystallization starting temperature Tx2 −20° C. When Tmax is less than Tx1 −20° C., crystallization does not progress sufficiently. When Tmax exceeds Tx2 −20° C., the compound crystalline phase is formed, and the coercivity largely increases. The recommended temperature for Tmax is equal to or greater than Tx1+(CB/CP)×5° C. and equal to or less than Tx2 −20° C. to cancel the miniaturization of the Cu clusters associated with the increase in B concentration. The Tmax is preferably equal to or greater than Tx1+(CB/CP)×5+20° C. In addition, the Tmax is preferably equal to or greater than Curie temperature of the non-crystalline phase. Increasing of Tmax increases the temperature at which the spinodal decomposition begins, increasing λm. Therefore, the total number of Cu clusters in the early stage of crystallization can be reduced, and large Cu clusters can be increased.

### Cooling Rate

As illustrated in FIG. 3C, when cooling is started, Cu being solid-solved in the Fe-rich phases newly forms a Cu-rich phase such as the Cu cluster 12c, and makes Cu-rich phases such as the Cu clusters 12a and 12b grow. The Fe-rich phase has magnetization, but Cu atoms being solid-solved in this phase and Fe atoms decrease the magnetization of Fe more than expected because of their quantum-mechanical action. This decreases the saturation magnetic flux density. Thus, a slower cooling rate 46 is preferable. On the other hand, a too slow cooling rate 46 increases the time required to manufacture the nanocrystalline alloy. Based on the above, the average cooling rate from when the temperature of the alloy reaches Tmax or Tx1+(CB/CP)×5 until it decreases to 200° C. is preferably 0.2° C./sec or greater and 0.5° C./sec or less.

### EXAMPLES

Samples were fabricated as follows.

### Manufacture of Non-Crystalline Alloy

As starting materials for the alloy, prepared were reagents such as iron (impurity of 0.01 weight % or less), boron (impurity of less than 0.5 weight %), triiron phosphide (impurity of less than 1 weight %), and copper (impurity of less than 0.01 weight %). It was confirmed beforehand that no loss of elements occurred in the process of manufacturing the nanocrystalline alloy from the mixture of these reagents.

Table 1 is a table presenting the chemical composition of each mixture, CB/CP and Tc (Curie temperature), Tx1 (the first crystallization starting temperature), and Tx2 (the second crystallization starting temperature). The concentration of each element in the nanocrystalline alloy coincides with the concentration of the corresponding element in the mixture if there is no loss of elements in the manufacture processes of ingots, non-crystalline alloys, and nanocrystalline alloys. That is, the chemical compositions B, P, Cu, and Fe in Table 1 correspond to CB, CP, CCu, and CFe, respectively. The total chemical composition of B, P, Cu, and Fe is 100.0 atomic %. In addition, Tx1 and Tx2 are two temperatures obtained by heating the non-crystalline alloy to approximately 650° C. at a constant heating rate of 40° C./min using a differential scanning calorimeter, and are defined in FIG. 2 and the like of Patent Document 4.

TABLE 1

| | | | | | CB/CP | | | |
|---|---|---|---|---|---|---|---|---|
| Steel | Chemical composition [at %] | | | | [at %/ | Tc | Tx | Tx2 |
| No. | B | P | Cu | Fe | at %] | [° C.] | [° C.] | [° C.] |
| 1 | 4.9 | 9.5 | 0.8 | 84.8 | 0.52 | 274 | 384 | 495 |
| 2 | 10.9 | 3.5 | 0.8 | 84.8 | 3.11 | 288 | 407 | 530 |

As presented in Table 1, a steel No. 1 and a steel No. 2 have the same composition of Fe and Cu, the steel No. 1 has CB/CP of 0.52, and the steel No. 2 has CB/CP of 3.11.

A mixture of 200 grams was prepared to achieve the chemical composition presented in Table 1. The mixture was heated in a crucible in an argon atmosphere to form a uniform molten metal. The molten metal was solidified in a copper mold to produce ingots.

The non-crystalline alloy is produced from the ingots using the single-roll method. The ingot of 30 grams was melted in a quartz crucible and discharged from a nozzle having an opening with 10 mm×0.3 mm onto a rotating roll of pure copper. A non-crystalline ribbon with a width of 10 mm, a thickness of 20 μm was formed as a non-crystalline alloy. The non-crystalline ribbon is peeled off from the rotating roll by argon gas jets.

Heat treatment such as the heat treatment described in FIG. 1 was performed in an argon gas stream using an infrared gold image furnace to produce ribbons, which were nanocrystalline alloys, from the non-crystalline alloys of the steel No. 1 and the steel No. 2.

Table 2 is a table presenting heat treatment conditions for manufacturing the nanocrystalline alloy from the non-crystalline alloy.

TABLE 2

| Manufacture No. | 1 | 2 | 3 | 4 | 5 | 6 | 7 | 8 | 9 | 10 | 11 |
|---|---|---|---|---|---|---|---|---|---|---|---|
| Heating rate | 40 | | | | | 400 | | | | | N/A |
| [° C./min] | | | | | | | | | | | |
| Maximum | 370 | 390 | 410 | 430 | 450 | 370 | 390 | 410 | 430 | 450 | |
| Temperature | | | | | | | | | | | |
| Tmax [° C.] | | | | | | | | | | | |
| First average | 0.33 | 0.35 | 0.37 | 0.38 | 0.39 | 0.36 | 0.38 | 0.39 | 0.40 | 0.41 | |
| cooling rate | | | | | | | | | | | |
| [° C./sec] | | | | | | | | | | | |
| Second average | 0.24 | 0.26 | 0.27 | 0.28 | 0.29 | 0.26 | 0.27 | 0.28 | 0.29 | 0.30 | |
| cooling rate | | | | | | | | | | | |
| [° C./sec] | | | | | | | | | | | |

The heating rate is a heating rate from room temperature to the maximum temperature Tmax and is substantially constant. The maximum temperature Tmax is the maximum temperature of the retention temperature T2. The retention temperature T2 in the retention period 42 is the maximum temperature Tmax and is substantially constant. The first average cooling rate is an average cooling rate from Tmax to 300° C., and the second average cooling rate is an average cooling rate from Tmax to 200° C. As presented in Table 2, in manufacture No. 1 to No. 5, the heating rate is 40° C./min, and in manufacture No. 6 to No. 10, the heating rate is 400° C./min. Among the manufacture No. 1 to No. 5, the maximum temperature Tmax of the retention temperature, the first average cooling rate, and the second average cooling rate were made to be different. Among the manufacture No. 6 to 10, Tmax, the first average cooling rate, and the second average cooling rate were made to be different. The length of the retention period 42 was constant at 10 minutes.

Table 3 is a table presenting the steel No., the manufacture No., and the coercivity Hc in each sample.

TABLE 3

| Sample No. | 1 | 2 | 3 | 4 | 5 | 6 | 7 | 8 | 9 | 10 | 11 |
|---|---|---|---|---|---|---|---|---|---|---|---|
| Steel No. | 1 | | | | | | | | | | |
| Manufacture No. | 1 | 2 | 3 | 4 | 5 | 6 | 7 | 8 | 9 | 10 | 11 |
| Coercivity [A/m] | 9.5 | 9.0 | 9.8 | 12.2 | 598.6 | 5.2 | 5.0 | 4.9 | 6.9 | 627.0 | 19.8 |

| Sample No. | 12 | 13 | 14 | 15 | 16 | 17 | 18 | 19 | 20 | 21 | 22 |
|---|---|---|---|---|---|---|---|---|---|---|---|
| Steel No. | 2 | | | | | | | | | | |
| Manufacture No. | 1 | 2 | 3 | 4 | 5 | 6 | 7 | 8 | 9 | 10 | 11 |
| Coercivity [A/m] | 83.3 | 47.1 | 35.5 | 40.3 | 41.4 | 72.5 | 11.7 | 10.5 | 8.4 | 8.8 | 13.5 |

Samples No. 1 to No. 10 are samples obtained by heat-treating the steel No. 1 under the conditions of the manufacture No. 1 to No. 10, respectively. Samples No. 12 to No. 21 are samples obtained by heat-treating the steel No. 2 under the conditions of the manufacture No. 1 to No. 10, respectively. The samples No. 11 and 22 are samples of the steel No. 1 and the steel No. 2 that were not subjected to heat treatment for forming the crystalline region 14, respectively.

### Measurement of Coercivity

The coercivities of the fabricated samples were measured using the DC magnetization property measurement device Model BHS-40. As presented in Table 3, the coercivity depends on the heating rate 45, the maximum temperature Tmax, and the average cooling rate 46. The sample No. 2 with the lowest Hc among the samples No. 1 to No. 5 was designated as Example 1. The sample No. 8 with the lowest Hc among the samples No. 6 to No. 10 was designated as Example 2. The sample No. 14 with the lowest Hc among the samples No. 12 to No. 16 was designated as Comparative example 1. The sample No. 20 with the lowest Hc among the samples No. 17 to No. 21 was designated as Example 3.

The samples of Examples 1, 2, and 3 all have lower coercivities Hc than the corresponding samples No. 11 and No. 22 before the heat treatment. In Comparative example 1 (the sample No. 14), the coercivity Hc is greater than 30 A/m and very high. In Examples 1, 2, and 3 (the samples No. 2, No. 8, and No. 20), the coercivity Hc is 10 A/m or less and low.

Table 4 is a table presenting the saturation magnetic flux density, the coercivity Hc, CP/CB×(ΔT+20), and Tx1+5×(CB/CP), in Examples and Comparative example.

TABLE 4

| | | Saturation | | | |
|---|---|---|---|---|---|
| | | magnetic | | CP/CB × | Tx1 + 5 × |
| | Sample | flux density | Coercivity | (ΔT + 20) | (CB/CP) |
| | No. | [T] | [A/m] | [° C.] | [° C.] |
| Example 1 | 2 | 1.70 | 9.0 | 116 | 387 |
| Example 2 | 8 | 1.71 | 4.9 | 814 | 387 |
| Comparative | 14 | 1.76 | 35.5 | 19 | 423 |
| example 1 | | | | | |
| Example 3 | 20 | 1.77 | 8.4 | 135 | 423 |

As presented in Table 4, the saturation magnetic flux densities of the samples of Examples 1 to 3 and Comparative example 1 are substantially the same. The samples of Examples 1 to 3 have a lower coercivity Hc than the sample of Comparative example 1. CP/CB×(ΔT+20) is large in Examples 1 to 3, and is small in Comparative example 1. As seen from the above, in Examples 2 and 3 in which the heating rate ΔT is large, the coercivity Hc is low. Even when the heating rate ΔT is small, in Example 1 with large CP/CB, the coercivity Hc is low. This is because when the heating rate ΔT is large and CP/CB is large, the size of each crystalline region 14 becomes small. Tx1+5×(CB/CP) is 387° C. in Examples 1 and 2, and is 423° C. in Comparative example 1 and Example 3.

### Atom Probe Tomography Analysis

For Examples 1 to 3 and Comparative example 1, the atom probe tomography analysis was conducted using the 3-dimensional atom probe (3DAP) CAMECA LEAP 5000XS. For this analysis, the analysis program IVAS (registered trademark), which is included in the 3DAP device, was used.

Table 5 is a table presenting Cu cluster densities Cu1.5, Cu3, Cu4.5, and Cu6, and Cu1.5/CCu and Cu1.5/Cu6 in Examples and Comparative example.

TABLE 5

| | | | | | | Cu1.5/ | Cu1.5/ |
|---|---|---|---|---|---|---|---|
| | Sam- | | | | | CCu | Cu6 |
| | ple | Cu1.5 | Cu3 | Cu4.5 | Cu6 | [10²⁴/ | [10²⁴/ |
| | No. | [10²⁴ Cu clusters/m³] | | | | m³/at %] | m³] |
| Example 1 | 2 | 2.4 | 1.8 | 0.8 | 0.28 | 3.0 | 8.6 |
| Example 2 | 8 | 1.9 | 1.9 | 1.4 | 0.85 | 2.4 | 2.2 |
| Compara- | 14 | 2.8 | 2.2 | 0.7 | 0.13 | 3.5 | 21.5 |
| tive ex- | | | | | | | |
| ample 1 | | | | | | | |
| Example 3 | 20 | 2.8 | 2.5 | 1.2 | 0.40 | 3.5 | 7.0 |

As presented in Table 5, in Examples 2 and 3 in which the heating rate ΔT is large, even when Cu1.5, which is considered to correlate with the total number of Cu clusters, is substantially the same as or less than those of Example 1 and Comparative example 1, Cu6, which is considered to correlate with the density of large Cu clusters, is larger than those of Example 1 and Comparative example 1. In the alloys with small CB/CP as in Examples 1 and 2, Cu6 is large also in Example 1 in which the heating rate ΔT is small. As described above, it is considered that when the heating rate ΔT is large and CB/CP is small, large Cu clusters increase, and the coercivity becomes lower.

Table 6 is a table presenting the average atomic concentrations C9Fe, C9P, C9B, and C9Cu of respective elements in the regions 68e with an Fe concentration of 90 atomic % or greater, and the average atomic concentrations C8Fe, C8P, C8B, and C8Cu of the respective elements in the regions 68c with an Fe concentration of 80 atomic % or less, in Examples and Comparative Example.

TABLE 6

| | Sample | C9Fe | C9P | C9B | C9Cu | C8Fe | C8P | C8B | C8Cu |
|---|---|---|---|---|---|---|---|---|---|
| | No. | [atomic %] | | | | [atomic %] | | | |
| Example 1 | 2 | 94.6 | 3.5 | 1.3 | 0.52 | 74.5 | 15.7 | 8.7 | 1.12 |
| Example 2 | 8 | 94.7 | 3.3 | 1.5 | 0.53 | 74.2 | 16.2 | 8.4 | 1.24 |
| Comparative | 14 | 96.3 | 1.3 | 1.8 | 0.58 | 75.5 | 4.8 | 18.8 | 0.92 |
| example 1 | | | | | | | | | |
| Example 3 | 20 | 96.2 | 1.3 | 2.0 | 0.50 | 71.8 | 6.3 | 20.9 | 1.07 |

Table 7 is a table presenting C9P/CP, C8P/CP, C9B/√CB, and C8Cu/C9Cu in Examples and Comparative example.

TABLE 7

| | | C9P/CP | C8p/CP | | C8Cu/C9Cu |
|---|---|---|---|---|---|
| | Sample | [at %/ | [at %/ | C9B/√CB | [at %/ |
| | No. | at %] | at %] | [atomic %^{0.5}] | at %] |
| Example 1 | 2 | 0.37 | 1.7 | 0.59 | 2.15 |
| Example 2 | 8 | 0.35 | 1.7 | 0.68 | 2.34 |
| Comparative | 14 | 0.37 | 1.4 | 0.54 | 1.59 |
| example 1 | | | | | |
| Example 3 | 20 | 0.37 | 1.8 | 0.61 | 2.14 |

As presented in Table 7, the alloys with large C8P/CP, large C9B/√CB, and large C8Cu/C9Cu have low coercivity. These can be explained by the model described in FIG. 4A to FIG. 4C.

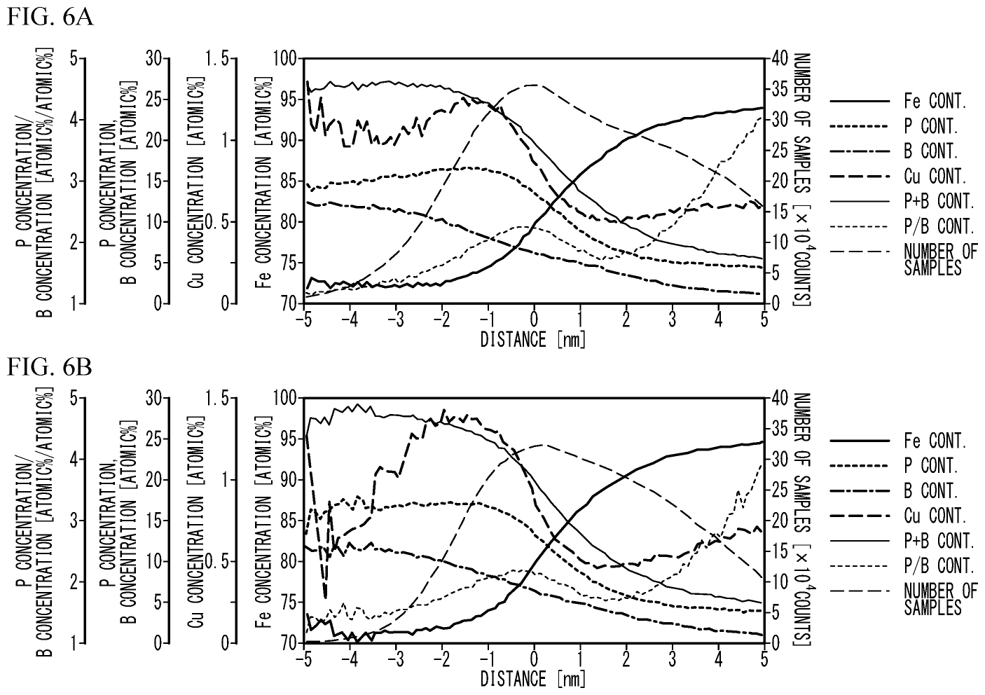

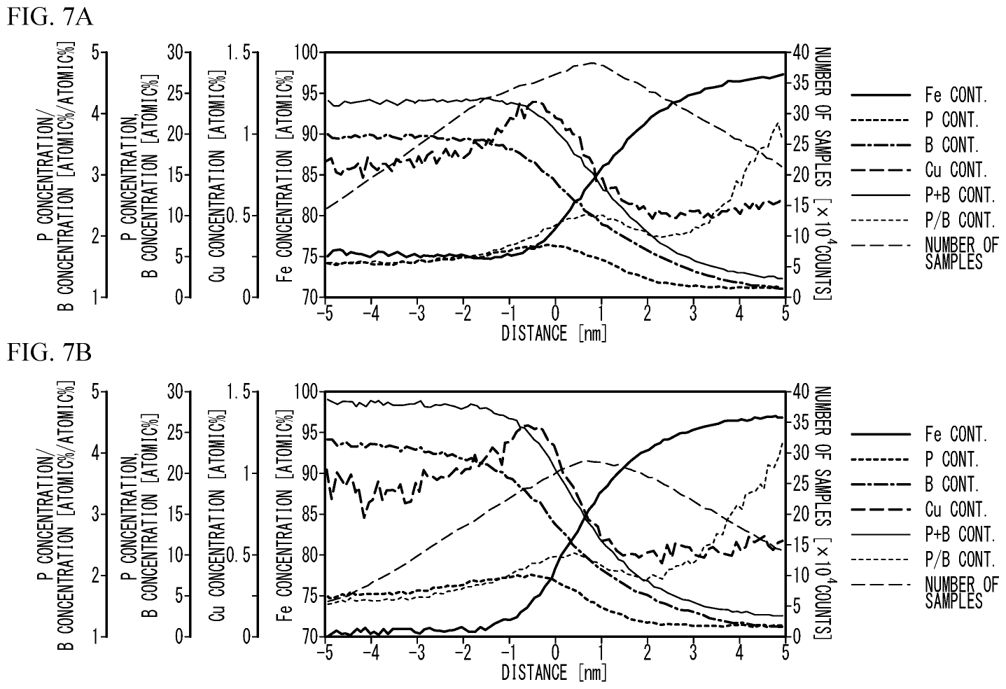

FIG. 6A to FIG. 7B are proxigrams of Examples 1 and 2, Comparative example 1, and Example 3, respectively. The isoconcentration surface with an Fe concentration of 80 atomic % is defined as a distance 0 (the boundary 66a), and the side with a higher Fe concentration (the direction toward the crystalline region 14) is defined as positive. In these figures, the Fe concentration, the P concentration, the B concentration, the Cu concentration, the P+B concentration, P concentration/B concentration, and the count number are presented by respective vertical axes.

As presented in FIG. 6A to FIG. 7B, the Fe concentration is high at positive distances, and is low at negative distances. The region with an Fe concentration of 90 atomic % or greater is considered to be substantially the crystalline region 14. The region around the distance 0 is considered to be the region 18. The P concentration and the Cu concentration are low at positive distances, and have local maximum values at around distance 0 or a slightly negative distance, and decreases as the distance goes from the local maximum value to negative sides. The B concentration is low at positive distances, and becomes higher as the distance goes in a negative direction. These can be explained by the model in which B preferentially migrates from the region 18 to the region 17 in FIG. 4A to FIG. 4C.

Table 8 is a table presenting P/Bmax, P/Bmax/(CP/CB), ΔFe, Cumax, Cuφ1, and Cuφ2 in Examples and Comparative example.

TABLE 8

| | | | | ΔFe | | | |
|---|---|---|---|---|---|---|---|
| | Sample | P/ | P/Bmax/ | [at %/ | Cumax | Cuφ1 | Cuφ2 |
| | No. | Bmax | (CP/CB) | nm] | [at %] | [nm] | [nm] |
| Example 1 | 2 | 2.24 | 1.16 | 0.0375 | 1.36 | 2.82 | 3.12 |
| Example 2 | 8 | 2.18 | 1.12 | 0.5139 | 1.42 | 3.20 | 4.06 |
| Compara- | 14 | 0.50 | 1.56 | −0.1901 | 1.20 | 2.76 | 2.78 |
| tive ex- | | | | | | | |
| ample 1 | | | | | | | |
| Example 3 | 20 | 0.51 | 1.59 | 0.1999 | 1.29 | 2.78 | 3.50 |

As presented in Table 8, when ΔFe is large, the coercivity is low. When Cumax is large, the coercivity is low. This is considered because the crystalline region 14 becomes smaller as P and Cu aggregate in the region 18 as described in FIG. 4A to FIG. 4C. When Cuφ1 and Cuφ2 are large, the coercivity Hc is low. This is considered because the migration of the magnetic domain wall is less likely to be inhibited and the coercivity is low since the crystalline region 14 becomes smaller as well as the total number of Cu clusters becomes smaller when Cuφ1 and Cuφ2 are large.

Although preferred embodiments of the present invention have been described so far, the present invention is not limited to those particular embodiments, and various changes and modifications may be made to them within the scope of the invention claimed herein.

### DESCRIPTION OF REFERENCE CHARACTERS

10 Alloy

12a-12c Cu clusters

14 Crystalline region

16 Non-crystalline region

17, 18 Regions

20 Fe atom

22 B atom

24 P atom

26 Cu atom

60, 60a-60e, 68c-68e Regions

1. An alloy,
wherein the alloy contains Fe, B, P, and Cu,
wherein the alloy includes a non-crystalline phase and a plurality of crystalline phases formed in the non-crystalline,
wherein an average Fe concentration in a whole alloy is 79 atomic % or greater, and
wherein a density of Cu clusters when a region with a Cu concentration of 6.0 atomic % or greater among regions with 1.0 nm on a side in atom probe tomography is determined to be a Cu cluster is 0.20×10²⁴/m³.

2. An alloy,
wherein the alloy contains Fe, B, P, and Cu,
wherein the alloy includes a non-crystalline phase and a plurality of crystalline phases formed in the non-crystalline phase,
wherein an average Fe concentration in a whole alloy is 79 atomic % or greater, and
wherein an average Fe concentration in a region with an Fe concentration of 80 atomic % or less among regions with 1.0 nm on a side in atom probe tomography is 74.5 atomic % or less.

3. An alloy,
wherein the alloy contains Fe, B, P, and Cu,
wherein the alloy includes a non-crystalline phase and a plurality of crystalline phases formed in the non-crystalline phase,
wherein an average Fe concentration in a whole alloy is 79 atomic % or greater, and
wherein a value obtained by dividing an average B atomic concentration in a region with an Fe concentration of 90 atomic % or greater among regions with 1.0 nm on a side in atom probe tomography by a square root of an average B atomic concentration in the whole alloy is 0.56 atomic %^{0.5} or greater.

4. An alloy,
wherein the alloy contains Fe, B, P, and Cu,
wherein the alloy includes a non-crystalline phase and a plurality of crystalline phases formed in the non-crystalline phase,
wherein an average Fe concentration in a whole alloy is 79 atomic % or greater, and
wherein a value obtained by dividing an average Cu atomic concentration in a region with an Fe concentration of 80 atomic % or less among regions with 1.0 nm on a side in atom probe tomography by an average Cu atomic concentration in a region with an Fe concentration of 90 atomic % or greater among the regions is 1.8 or greater.

5. An alloy,
wherein the alloy contains Fe, B, P, and Cu,
wherein the alloy includes a non-crystalline phase and a plurality of crystalline phases formed in the non-crystalline phase,
wherein an average Fe concentration in a whole alloy is 79 atomic % or greater, and
wherein in a proxigram of regions with 1.0 nm on a side in atom probe tomography with respect to a boundary with an Fe concentration of 80 atomic %, a slope of an Fe concentration through a position of −2.0 nm from the boundary and a position of −4.0 nm from the boundary is 0.03 atomic %/nm or greater when a direction toward the crystalline phase is defined as positive.

6. An alloy,
wherein the alloy contains Fe, B, P, and Cu,
wherein the alloy includes a non-crystalline phase and a plurality of crystalline phases formed in the non-crystalline phase,
wherein an average Fe concentration in a whole alloy is 79 atomic % or greater, and
wherein a value obtained by dividing a density of Cu clusters when a region with a Cu concentration of 1.5 atomic % or greater among regions with 1.0 nm on a side in atom probe tomography is determined to be a Cu cluster by a density of Cu clusters when a region with a Cu concentration of 6.0 atomic % or greater among the regions is determined to be a Cu cluster is 15 or less.

7. An alloy,
wherein the alloy contains Fe, B, P, and Cu,
wherein the alloy includes a non-crystalline phase and a plurality of crystalline phases formed in the non-crystalline phase,
wherein an average Fe concentration in a whole alloy is 79 atomic % or greater, and
wherein in a region with an Fe concentration of 80 atomic % or less among regions with 1.0 nm on a side in atom probe tomography, an average spherical equivalent diameter of Cu clusters when a region with a Cu concentration of 2.3 atomic % or greater among the regions is determined to be a Cu cluster is 3.0 nm or greater.

8. The alloy according to claim 1,
wherein the average Fe concentration in the whole alloy is 83 atomic % or greater and atomic % or less,
wherein an average B concentration in the whole alloy is 2.0 atomic % or greater and 12 atomic % or less,
wherein an average P concentration in the whole alloy is 2.0 atomic % or greater and 12 atomic % or less,
wherein an average Cu concentration in the whole alloy is 0.4 atomic % or greater and 1.4 atomic % or less,
wherein a sum of an average Si concentration and an average C concentration in the whole alloy is 0 atomic % or greater and 3.0 atomic % or less, and
wherein an average atomic concentration of an element other than Fe, B, P, Cu, Si, and C in the whole alloy is 0 atomic % or greater and 0.3 atomic % or less.

9. The alloy according to claim 1, wherein a value obtained by dividing an average B atomic concentration by an average P atomic concentration in the whole alloy is 1.5 or greater and 3.5 or less.

10. The alloy according to claim 1, wherein a value obtained by dividing a density of Cu clusters when a region with a Cu concentration of 1.5 atomic % or greater among the regions is determined to be a Cu cluster by an average Cu atomic concentration in the whole alloy is 3.0×10²⁴/m³/atomic % or less.

11. The alloy according to claim 1, wherein a value obtained by dividing an average P atomic concentration in a region with an Fe concentration of 90 atomic % or greater among the regions by an average P atomic concentration in the whole alloy is 0.36 or less.

12. The alloy according to claim 1, wherein a value obtained by dividing an average P atomic concentration in a region with an Fe concentration of 80 atomic % or less among the regions by an average P atomic concentration in the whole alloy is 1.6 or greater.

13. The alloy according to claim 1, wherein in a proxigram of the regions with respect to a boundary with an Fe concentration of 80 atomic %, a maximum value of a Cu concentration is 1.25 atomic % or greater within a range of ±5.0 nm from the boundary.

14. The alloy according to claim 1, wherein in a proxigram of the regions with respect to a boundary with an Fe concentration of 80 atomic %, P atomic concentration/B atomic concentration has a local minimum value and a local maximum value within a range of ±5.0 nm from the boundary.

15. The alloy according to claim 1, wherein in a proxigram of the regions with respect to a boundary with an Fe concentration of 80 atomic %, a local maximum value of P atomic concentration/B atomic concentration is 1.0 or greater within a range of ±3.0 nm from the boundary.

16. The alloy according to claim 1, wherein in a proxigram of the regions with respect to a boundary with an Fe concentration of 80 atomic %, a value obtained by dividing a local maximum value of P atomic concentration/B atomic concentration within a range of ±3.0 nm from the boundary by average P atomic concentration/average B atomic concentration in the whole alloy is 1.0 or greater.

17. The alloy according to claim 1, wherein in a region with an Fe concentration of 80 atomic % or greater among the regions, an average spherical equivalent diameter of Cu clusters when a region with a Cu concentration of 2.3 atomic % or greater among the regions is determined to be a Cu cluster is 3.0 nm or greater.
